(19) United States
(12) Patent Application Publication
(10) Pub. No.: US 2012/0161975 A1
(43) Pub. Date: Jun. 28, 2012

(54) Notifying a Passenger of Overweight Luggage

(75) Inventors: Carole Ann Stewart, North Shields (GB); Gerard James Stewart, North Shields (GB)

(73) Assignee: WEIGH-AHEAD UKENA LIMITED, Newcastle-upon-Tyne (GB)

(21) Appl. No.: 13/015,821

(22) Filed: Jan. 28, 2011

(30) Foreign Application Priority Data
Dec. 23, 2010 (GB) 1021994.7

(51) Int. Cl. G08B 21/00

(52) U.S. Cl. 340/666

(57) ABSTRACT

Passengers are notified as to whether an item if luggage is overweight. Information relating to a journey is received for which a passenger has a ticket and an item of luggage is weighed such that this may be compared with a maximum weight allowed for the luggage item. An extent to which the luggage is overweight is indicated so that a passenger may reduce this weight or accept that an additional payment is required. In order to provide accurate results while reducing the overall size of the data stored, information relating to a journey includes first data identifying a carrier and second data identifying a destination.

### CROSS REFERENCE TO RELATED APPLICATIONS

This application claims priority from United Kingdom patent application number 10 21 994.7 filed 23 Dec. 2010, the entire disclosure of which is incorporated herein by reference.

### BACKGROUND OF THE INVENTION

1. Field of the Invention

The present invention relates to a method of notifying a passenger as to whether an item of luggage is overweight. The present invention also relates to apparatus for notifying a passenger as to whether an item of luggage is overweight and a database for use in a system for notifying a passenger as to whether an item of luggage is overweight.

2. Description of the Related Art

Current systems for notifying a passenger of overweight luggage exist in which information is entered relating to a journey for which a passenger has a ticket. Luggage is weighed and the weight of the luggage is compared with the maximum weight of luggage allowed for the particular ticket. The extent to which the luggage is overweight is then indicated to the passenger.

A problem with producing a system of this type is that in order for every indication of overweight luggage to be correct, it is necessary to make reference to a substantial volume of data. Furthermore, this data must be obtained from all relevant carriers and as such different rules may apply and the data may be presented in different formats.

In a first known system the information relating to a journey only identifies the carrier and the class of ticket. However, problems may arise because a particular carrier may issue tickets of similar classes but with differing luggage allocations applied thereto.

In an alternative proposal, it would be possible to maintain a database recording luggage allowances for all ticket classes on all flights. However, the burden involved in terms of maintaining such a database would result in the creation of a system that was uneconomic to deploy within the intended environment.

It has also been appreciated that greater emphasis is being placed on luggage allowances given the increasing number of routes serviced by budget carriers. These budget carriers may make provision for payments to be made for additional luggage to be carried but with the result that they introduce a greater level of sophistication and price differentiation concerning luggage allowances and the parameters considered when calculating a luggage allowance.

### BRIEF SUMMARY OF THE INVENTION

According to an aspect of the present invention, there is provided a method of notifying a passenger as to whether an item of luggage is overweight, including the steps of: receiving information relating to a journey for which a passenger has a ticket; weighing said item of luggage to identify a weight for said item of luggage; comparing said weight of said item of luggage with a maximum weight allowed value for a luggage item for said ticket; and indicating the extent to which said item of luggage is overweight, wherein said step of receiving information relating to a journey includes: receiving first data identifying a carrier for said journey; and receiving second data identifying a destination; and said maximum weight allowed value is read from a database with reference to said first data and said second data without requiring further details of the actual journey.

### BRIEF DESCRIPTION OF THE DRAWINGS

FIG. 1 shows a control station communicating over a network;

FIG. 2 details the control station identified in FIG. 1;

FIG. 3 identifies procedures performed by the processing system identified in FIG. 2;

FIG. 4 details a data source table identified in FIG. 2;

FIG. 5 shows an example of a master allowance table;

FIG. 6 details a location table and a carrier table identified in FIG. 2;

FIG. 7 details procedures for updating remote databases identified in FIG. 3;

FIG. 8 shows an apparatus for notifying a passenger as to whether an item of luggage is overweight;

FIG. 9 shows an electronic processing system of the type identified in FIG. 8;

FIG. 10 details procedures performed by the processor shown in FIG. 9;

FIG. 11 shows an example of a remote allowance table;

FIG. 12 details procedures for luggage weighing, as identified in FIG. 10;

FIG. 13 details procedures for performing the weighing process as identified in FIG. 12;

FIG. 14 details a graphical user interface;

FIG. 15 shows an example of a session table; and

FIG. 16 shows an example of a printed report.

### DETAILED DESCRIPTION OF EXAMPLE EMBODIMENTS

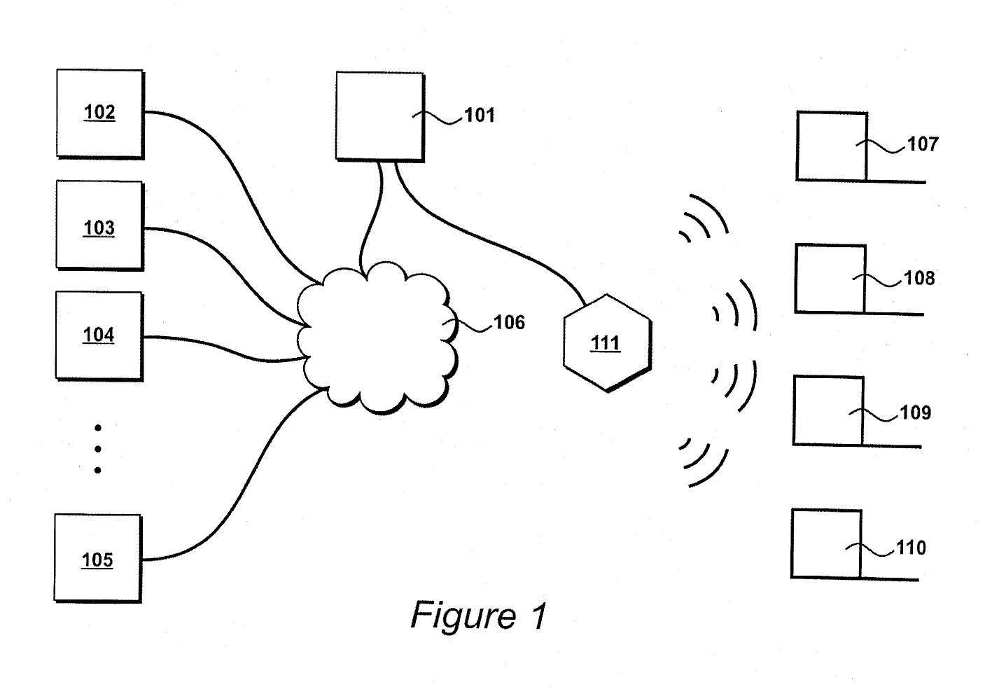

FIG. 1

A control station 101 communicates with a plurality of apparatus for notifying passengers as to whether an item of luggage is overweight. Luggage allowance data is received from transportation carriers 102, 103, 104, 105 etc. In an embodiment, these transportation carriers represent airlines, each making data available as to luggage weight allocations for particular classes of ticket on particular flights. In an embodiment, this information is available via respective websites and the information is supplied to the control station 101 via the Internet 106, or similar network.

The notification apparatus is resident at transportation ports, such as airport 107, 108, 109 and 110. In an embodiment, notification apparatus may be connected to internal data networks within the airport or a service specific wireless network could be established within the airport. However, in the embodiment described herein, communication between control station 101 and the individual notification apparatus is provided by a cellular mobile telephony network 111.

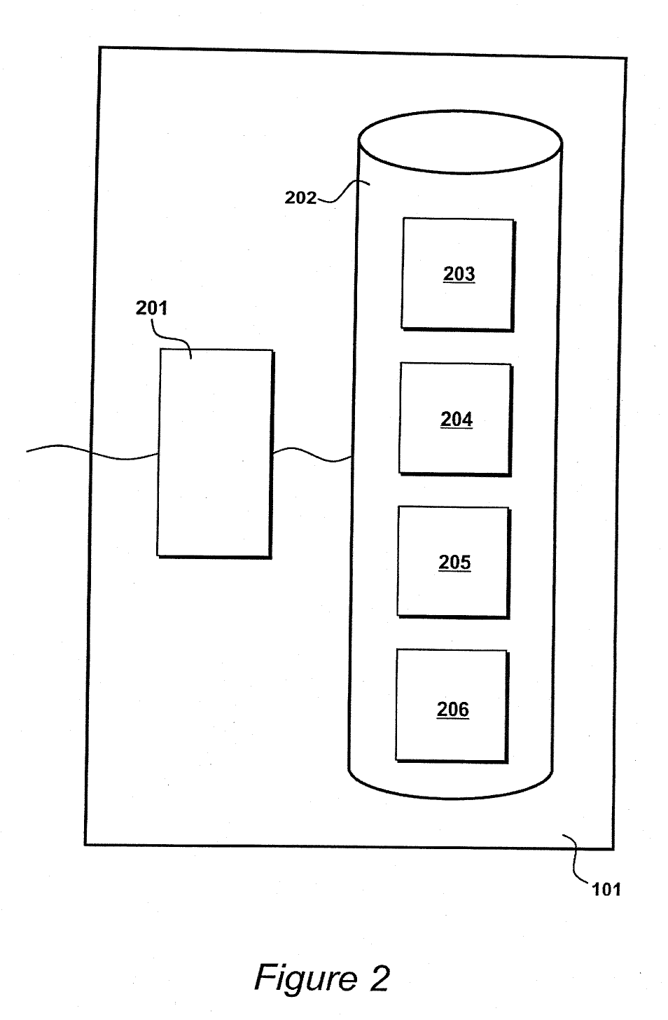

FIG. 2

Control station 101 is detailed in FIG. 2. It includes a processing system 201 that communicates with network 106 and also communicates with a database system 202. The database system 202 includes a data source table 203, a master allowance table 204, a location table 205 and a carrier table 206.

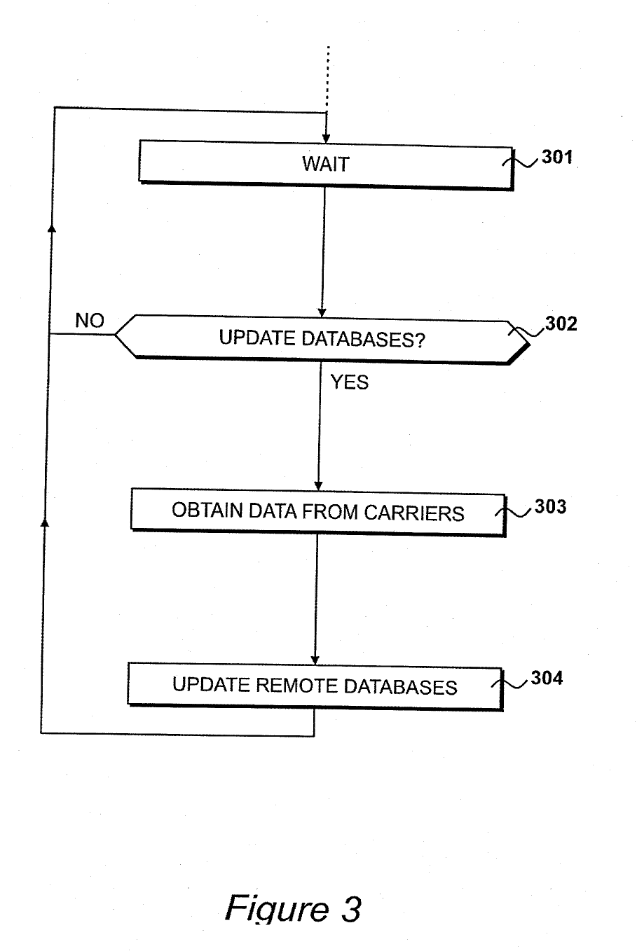

FIG. 3

Procedures perform by processing system 201 are shown in FIG. 3. After a wait state 301, a question is asked at step 302 as to whether databases are to be updated. If the question asked at step 302 is answered in the negative, control is returned to step 301 for the duration of a further wait period.

If the question asked at step 302 is answered in the affirmative, data is obtained from carriers 102 to 105 via network 106. This results in the master allowance table 204 being updated. When all carriers have been considered, control is directed to step 304 where remote databases are updated, located at 107 to 110, via mobile telephony network 111.

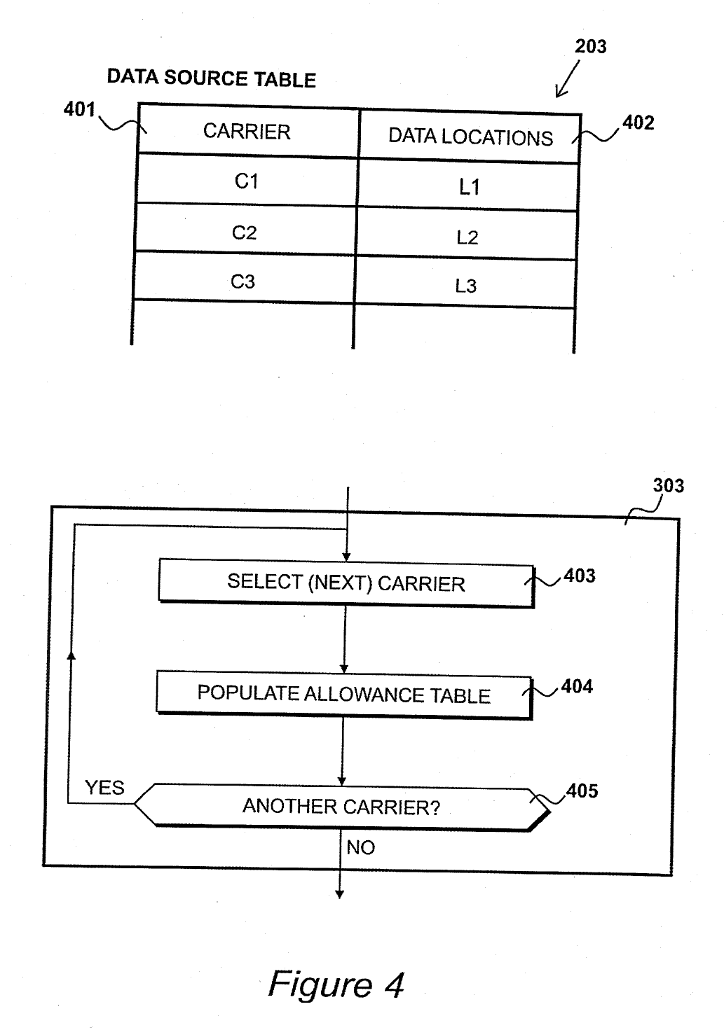

FIG. 4

Data source table 203 is detailed in FIG. 4. This includes a first column 401 identifying the name of each carrier along with a second column 402 identifying a data location for the respective carrier. Thus, a first carrier C1 is identified with a data location L1. In this example, a carrier C2 is identified with data located at location L2 and for carrier C3 data is obtained from location L3. In an embodiment, locations L1 to L3 are URLs identifying the location of webpages from which luggage allowance data for each respective carrier may be obtained.

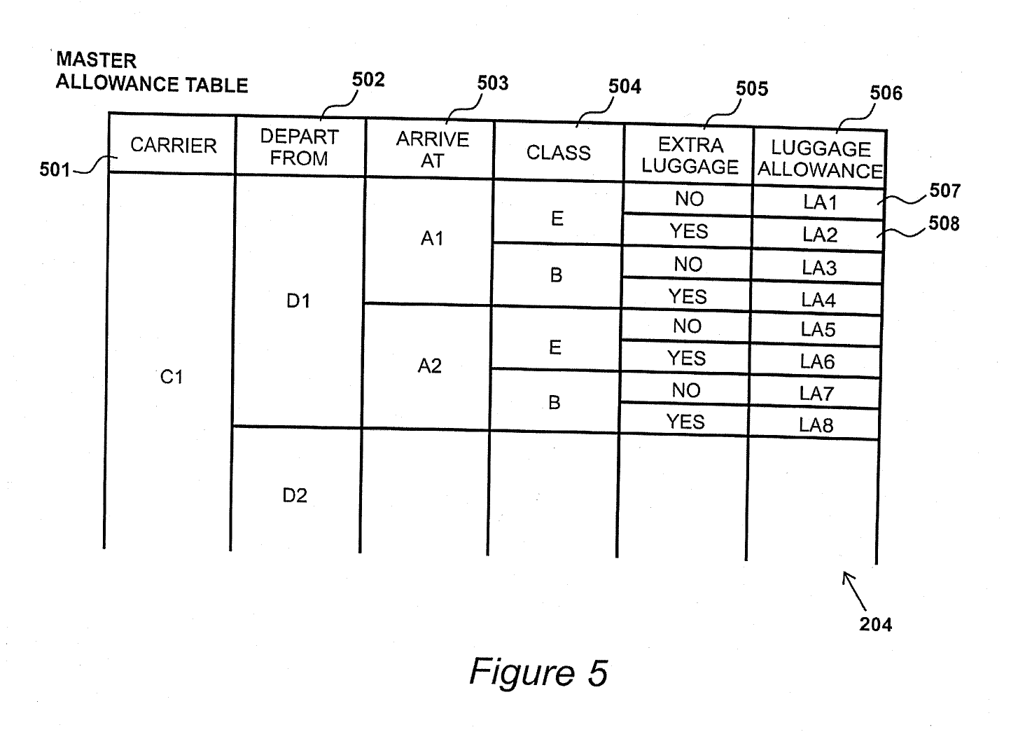

Process 303 for obtaining data from carriers is also detailed in FIG. 4. At step 403 a carrier is selected and at step 404 the master allowance table (detailed in FIG. 5) is populated. Thus, the first carrier C1 is selected at step 403 and data concerning luggage weight allowances are derived by receiving data from data location L1. This results in the allowance table 204 being populated and a question then being asked at step 405 as to whether another carrier is to be selected.

When the question asked at step 405 is answered in the affirmative, control is returned to step 403 and the next carrier (such as carrier C2) is selected resulting in data being received from location L2. Thus, this process continues until all of the carriers have been considered.

FIG. 5

An example of a master allowance table is illustrated in FIG. 5. The master allowance table is populated by considering each carrier in turn. Thus, a first column 501 identifies the carrier. A second column 502 identifies the departure location, which will be the location of the remote apparatus for notifying passengers.

Column 503 identifies the destination or the location at which the arrival will take place. Column 504 identifies the class of ticket and column 505 identifies the option of an extra fee being paid for the carrying of additional luggage. Thus, in this embodiment, an assumption is made to the effect that a standard luggage allowance is provided for each ticket and for each ticket it is possible to purchase an additional increment of luggage weight.

Column 506 identifies the actual luggage allowance, represented in kilograms in this example, and a charge per additional kilogram.

It is appreciated that the sophistication of extra baggage charges may increase over time and it may become necessary to update the system. To accommodate more sophisticated overweight charges, it is possible for the database to allow multiple overweight entries for each airline destination, in which the total charge is calculated as a sum of all weights across all bands. For example, a first airline may charge ten dollars per kilogram for being overweight between 5 kg and 10 kg, fifteen dollars per kilogram between 10 kg and 20 kg and a flat rate of fifty dollars thereafter. This requires three overweight entries to be provided in the database detailing each of these three bands. In this example, if an item weighed 12 kg over the standard allowance, the charge would be calculated as fifty dollars for the first band plus thirty dollars for the second band and the user would be shown a total additional charge of eighty dollars. A band could be marked has being a flat rate band, in which case if the weight is in that band then regardless of their overweight value a flat rate would be charged. Thus, if the weight was 25 kg the user would be presented with a charge indication of fifty dollars.

During the exercise of step 404, carrier C1 is selected and the first departure location D1 is selected. Thereafter, the first destination or arrival location A1 is selected, followed by a selection of economy class in this example. Next, an assumption is made that no additional charge has been paid resulting in an actual indication of luggage allowance data LA1 being updated in record 507.

Following this, the same departure location is considered, at the same arrival location, for the same class but with an extra luggage payment being made. This results in an identification of luggage allowance data LA2 that populates record 508.

For the purposes of this illustration, it is assumed that the class of the ticket may be economy (represented by an “E”) or business, represented by a “B”. However it is appreciated that for some budget airlines and internal flights, only a single class may be present, in which case several luggage allowance values would be equal. However, in an enhanced embodiment, provision is made for additional classes, such as a premium economy class, a premium business class, first class and other enhanced types of classes as these become available. For example, further sub divisions may be required as enhanced provisions are provided by very large modern aircraft.

Thus, it can be appreciated with reference to FIG. 5, that all of the possibilities are populated for a particular carrier, including all of the relevant departure locations, whereafter the next carrier is selected, as indicated at step 403 and the master allowance table 204 continues to be populated.

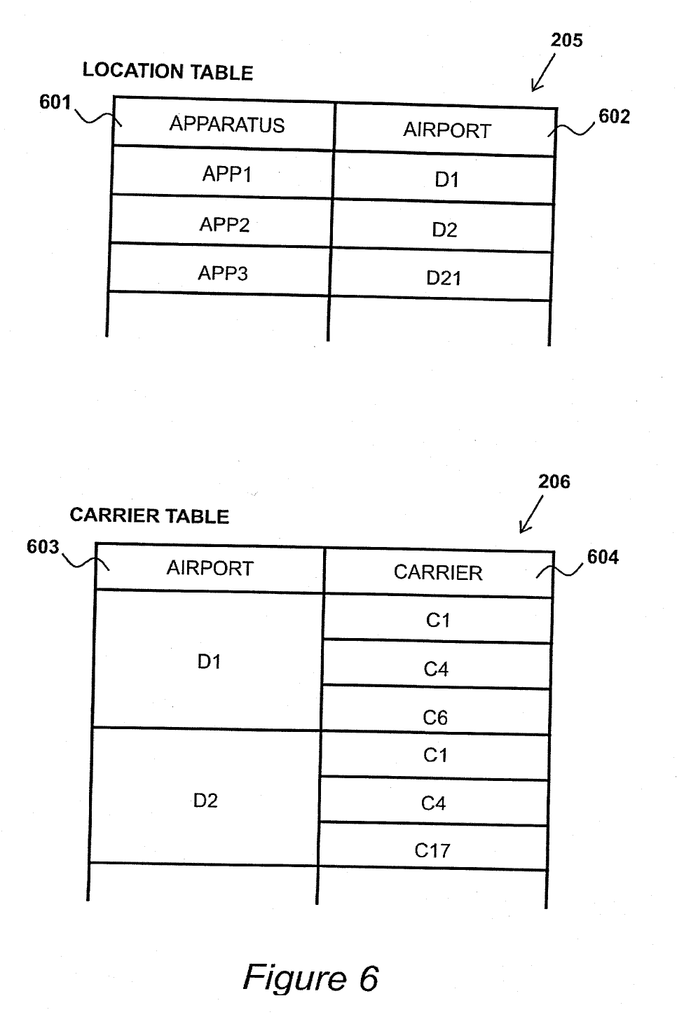

FIG. 6

The location table 205 and the carrier table 206 are detailed in FIG. 6.

The location table 205 identifies the location of each individual notification apparatus. Thus, in an embodiment, a first column 601 provides a unique identification for each item of apparatus and a second column 602 identifies the specific airport where the apparatus is located. In an embodiment, each apparatus is contacted via a cellular mobile telephony network therefore in an embodiment, individual units of the apparatus may be identified by their unique cellular telephone number, as used for data transmission. Thus, in table 205 a first apparatus APP1 is shown at departure airport D1, with apparatus APP2 also being located at departure airport D1 and apparatus APP3 being located at departure airport D21.

Carrier table 260 includes a first column 603 identifying destination airports followed by a second column 604 identifying all of the carriers that are operational for the selected destination airports. Thus, in this example, airport D1 is identified at column 603 with carriers C1, C4 and C6, each being operational from destination airport D1. Similarly, destination airport D2 is identified with carriers C1, C4 and C17.

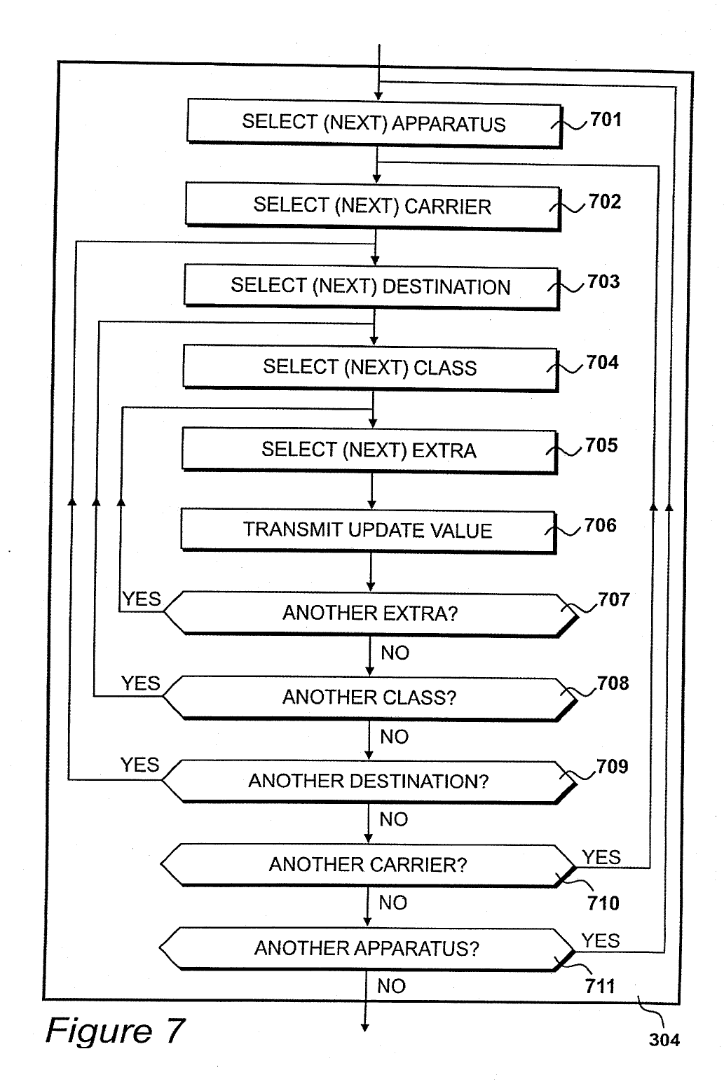

FIG. 7

Procedures 304 for updating remote databases are detailed in FIG. 7.

At step 701 an apparatus is selected, such as apparatus APP1 which is identified, from table 205, as being resident at departure airport D1.

At step 702 a carrier is selected and from table 260 it is known that carrier C1 operates from destination airport D1, along with carrier C4 and carrier C6.

At step 703 a destination is selected, referenced in column 503 of table 204 as an arrival airport. Thus, with reference to table 204 (or from a more efficiently indexed version of this table) it is possible to identify destinations A1 and A2 as being relevant for the combination of carrier C1 with departure airport D1.

At step 704 a class is selected, this being the economy class in column 504 on the first iteration, followed by the selection of the next extra luggage entry which, on the first iteration with reference to column 505, will be an indication to the effect that no payment has been made for extra luggage. Thus, at step 706 it is possible to identify luggage allowance data LA1, that may be transmitted to the remote apparatus selected at step 701.

At step 707 a question is asked as to whether another extra luggage entry exists which on the first iteration will be answered in the affirmative resulting in the second extra luggage selection being made at step 705 and data entry LA2 being transmitted at step 706.

On the next iteration, the question asked at step 707 will be answered in the negative because all extra luggage options have been considered. At step 708 a question is asked as to whether another class is present. On the first iteration this question will be answered in the affirmative as the economy class options were considered previously therefore the business class options will now be considered. Again, data entries exist for no extra luggage payment being made and for an extra luggage payment being made. Thus, after transmitting two items of data, the question asked at step 708 will be answered in the negative.

A question is asked at step 709 as to whether another destination is present and having considered all the options for destination A1, the question will be answered in the affirmative in order to consider the options for destination A2. On the subsequent iteration, in this example, the question asked at step 709 will be answered in the negative as all destinations for carrier C1, operating from airport D1, will have been considered.

In the example shown, two destinations are identified for the purposes of example only. In practice, it is likely that most carriers will fly to a significantly higher number of destinations from a particular airport. The majority of carriers identify three levels of destination for luggage allowance calculation purposes. Presently, these tend to be identified as short haul, medium haul and the long haul. However, an embodiment includes sufficient flexibility for any charges to be made for a particular destination. However, it is not necessary to retain data relating to each individual flight as luggage allowances and additional charges will tend to be the same irrespective of the time of the flight; thus allowing the total quantity of data retained in the database to be minimised while providing the required level of accuracy.

In an embodiment, the luggage allowance data (such as data value LA1) effectively includes two items of data. A first identifies the maximum weight of luggage that may be carried as a particular item of luggage before additional charges are required. The second datum identifies the additional charge per additional kilogram (or other weight unit) above the allocated allowance.

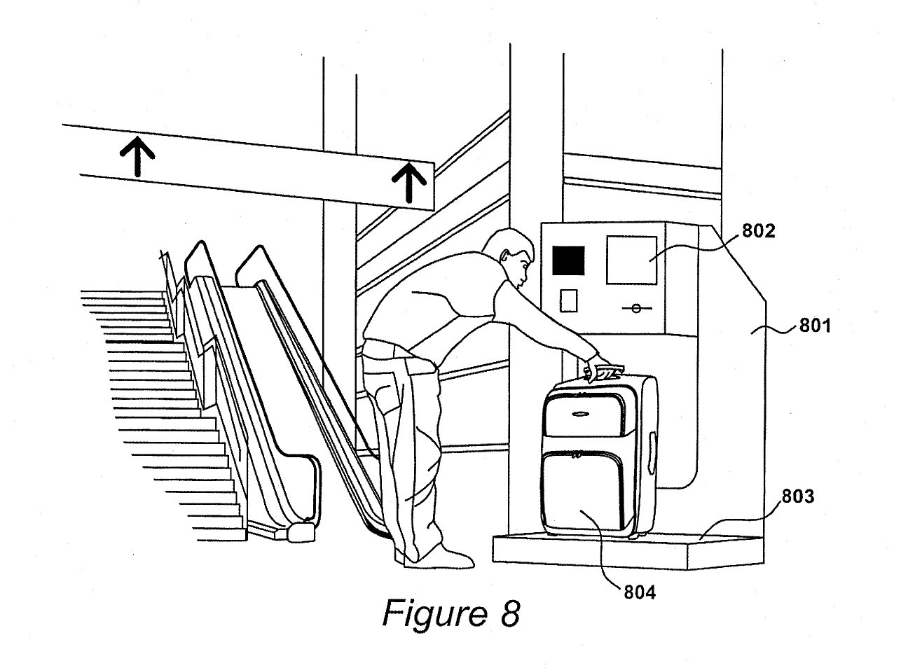

FIG. 8

An apparatus 801 for notifying a passenger as to whether an item of luggage is overweight is shown in FIG. 8. As illustrated, the apparatus 801 is located at a convenient position within an airport (or similar travel destination) on the land side of the airport (prior to check-in) close to passenger transit paths. The apparatus includes an input interface 802 which may take the form of touch screen for example. The input interface receives information relating to a journey for which the passenger has a ticket.

The apparatus also includes a weighing device 803 for weighing an item of luggage, such as item 804. Thus, in this example, an item of luggage 804 has been placed on the weighing device 803 by a passenger in transit.

The apparatus 801 essentially provides an enclosure, as shown in FIG. 8, with electronic processing devices contained within said enclosure.

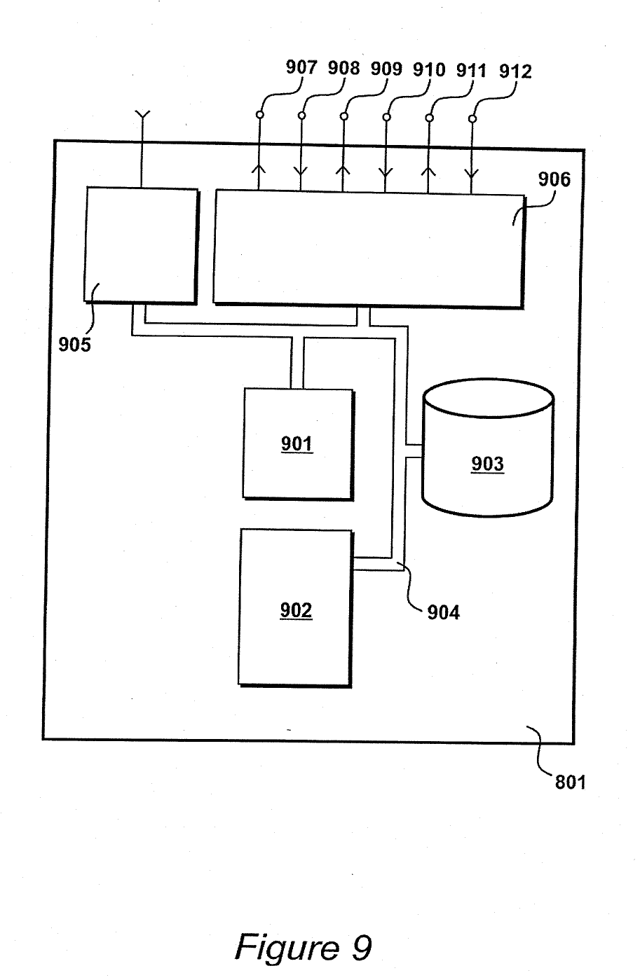

FIG. 9

Electronic processing systems contained within apparatus 801 are detailed in FIG. 9. A processor 901 communicates with volatile random access memory 902 and permanent storage device 903 via a bus 904. Bus 904 also communicates with a mobile telephony module 905 and a local input/output circuit 906.

Interface 906 provides an output 907 to a payment device, along with an input 908 from said payment device.

Interface 906 also provides an output to touch screen 802, along with an input from said touch screen via an input 910.

The interface 906 provides an output 911 to a printer and receives an input 912 from the weighing device 803.

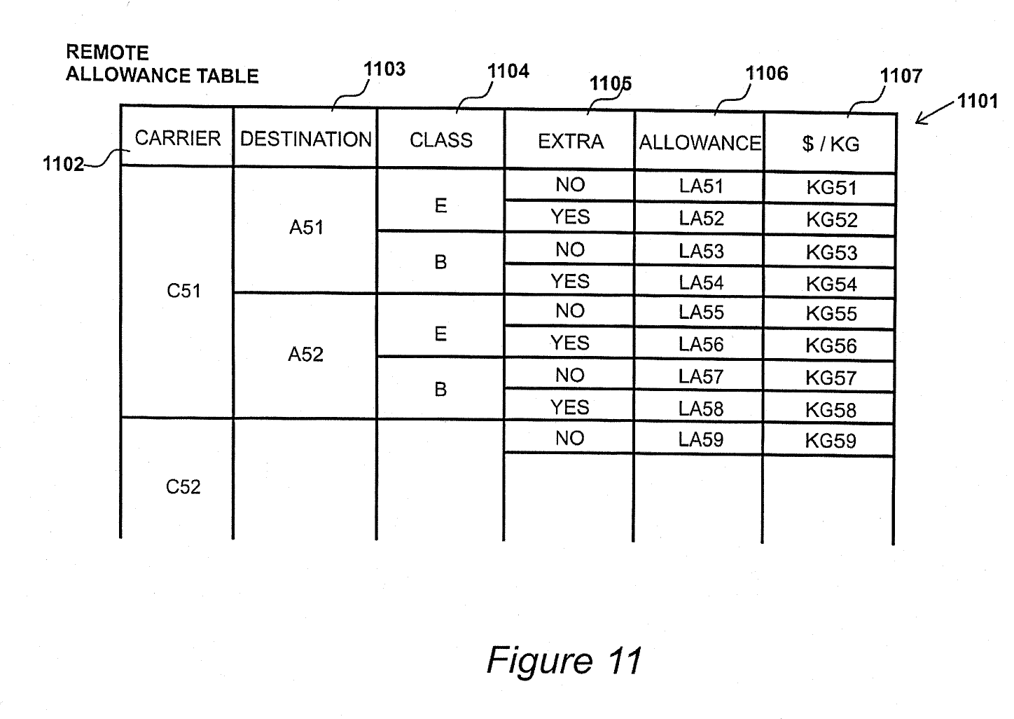

The touch screen 802 presents a graphical user interface to a passenger allowing input data to be received relating to a journey. The weighing device 803 weighs the item of luggage and processing device 901 compares the weight of the item of luggage with a maximum weight allowed for an item of luggage with the ticket. The comparison is made with reference to a local allowance table (detailed in FIG. 11) that may be contained within permanent storage device 903. The provision of the touch screen 802 also provides a first output interface for indicating the extent to which the item of luggage is overweight. In order to achieve this, the input interface receives information relating to a journey that includes first data identifying a carrier for the journey and second data identifying a destination. The maximum weight allowed is read from the local database, within storage device 903, making reference to the first data and the second data, identifying the carrier and the destination but not the specific flight; therefore no further details are required of the actual journey in order for an accurate assessment to be made.

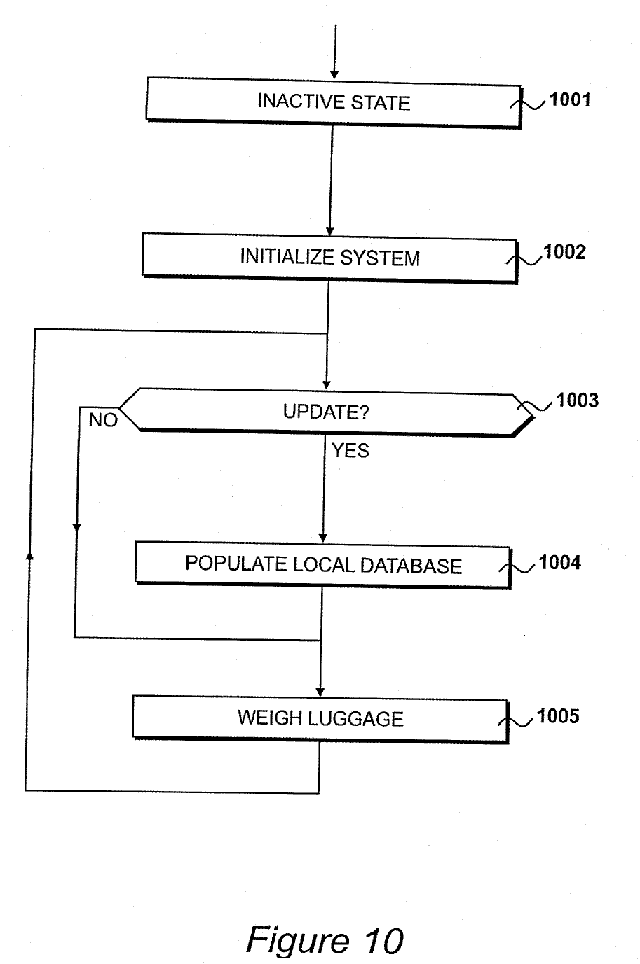

FIG. 10

Procedures performed by processor 901 are identified in FIG. 10. An inactive state is illustrated at step 1001, indicating that the apparatus is receiving power but has not been fully commissioned. Tests may be performed upon the apparatus to determine that communications are taking place correctly and the touch screen 802 may display a message to the effect that the equipment is out of service.

At step 1002 the system is initialized, as program instructions are read from permanent storage 903 and written to executable random access memory 902. When fully functional, a question is asked at step 1003 as to whether the local allowance table is to be updated.

When the question asked at step 1003 is answered in the affirmative, the local apparatus remains inactive as it awaits an update from control station 101. Thus, making reference to a real-time clock for example, it is possible for processor 901 to be aware as to when the last update was received and if this period exceeds a predetermined value, the system becomes inoperable until a further update has been received.

If the question asked at step 1003 is answered in the negative, to the effect that an update is not required, the apparatus is placed in an operational state at step 1005, where it is possible for luggage to be weighed.

FIG. 11

An example of a remote allowance table 1101 is illustrated in FIG. 11. In this example, a carrier is identified in column 1102, a destination (arrival airport) is identified in column 1103, a ticket class is identified in column 1104, an indication of an extra payment being made for additional luggage is identified in column 1105, a luggage allowance is included in column 1106 and the additional charge per additional unit weight is indicated in column 1107.

In an embodiment, the remote allowance tables are populated entry-by-entry as update information is derived. Alternatively, a remote allowance table may be constructed at the control station 101 and downloaded as a complete entity.

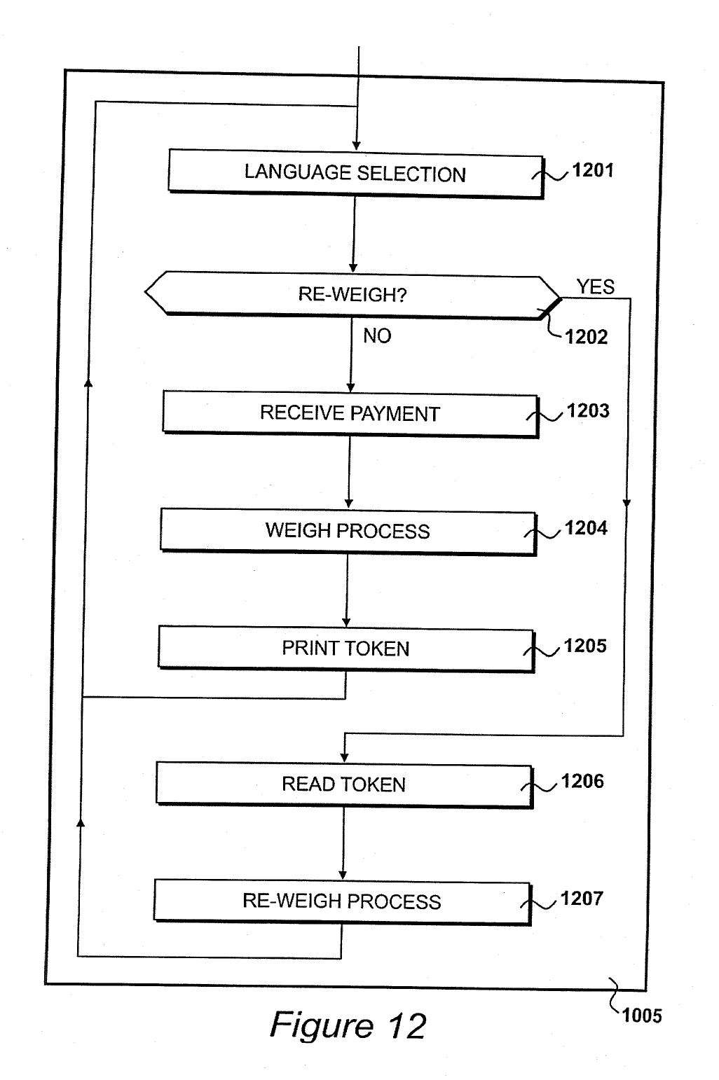

FIG. 12

Procedures 1005 for luggage weighing are detailed in FIG. 12. At step 1201a language selection is made from options displayed on touch screen 802.

The idea of the system is that passengers can check the weight of their luggage before they check-in. If they are over their allowance, the apparatus will tell them by how much and it will also tell them how much it will cost if they do check-in; thereby giving them an opportunity to redistribute their luggage. Furthermore, in an embodiment, it is possible for them to come back for a free re-weighing.

At step 1202 a question is asked as to whether a re-weighing operation is to be performed and when answered in the affirmative control is directed to step 1206.

On the first iteration, the question asked at step 1202 will be answered in the negative resulting in a request for payment being made. Upon the correct payment being received, the weighing process is conducted at step 1204.

Having completed the weighing process, a token or a ticket may be printed at step 1205, emerging from slot 805 identifying a unique code that is entered to initiate the re-weighing procedure. Thus, for the re-weighing procedure, a ticket or token is read at step 1206 and the re-weighing process is performed at step 1207.

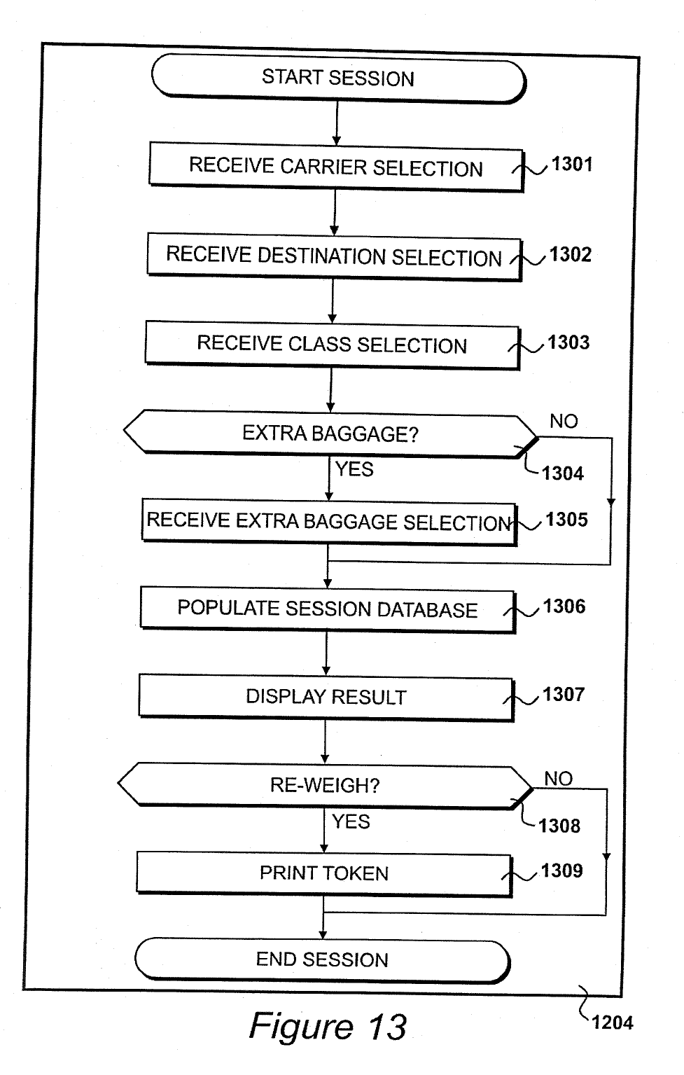

FIG. 13

Procedures 1204 for performing the weighing process are detailed in FIG. 13. At step 1301 the apparatus receives carrier selection data. In an embodiment, a user is presented with a QWERTY keyboard and prompted for the name of their carrier. Having indicated the first letter of their airline, an embodiment presents a list and a selection is made from this list which is confirmed by the pressing of an OK button.

At step 1302 the apparatus receives data identifying a selected destination. The inventors have appreciated that by receiving data identifying the specific carrier and the specific destination, it is possible to accurately determine the luggage allowance and the extent to which further payments may be made per unit of additional weight. In this way, accurate advice may be given to users, so as to avoid unpleasant situations, while at the same time the totality of the data stored within the system becomes acceptable. Typically, different rates are provided for long haul, middle distance and short hops and in an alternative embodiment, it would be possible for a selection of one of these travel types to be determined with reference to the departure airport and the arrival airport.

It has also been appreciated that luggage allowances are generally more important when using budget airlines. Thus, under these circumstances, the name of the carrier and the destination often provide sufficient information for an accurate assessment to be made.

On the basis that the system also operates with major carriers, data identifying the class of the ticket is received at step 1303 and at step 1304 a question is asked as to whether an additional luggage allowance has been obtained. In an embodiment, data is received via manual input identifying information carried on the ticket identifying a specific weight allowance.

After receiving extra baggage selection at step 1305, the touch screen 802 prompts the user to check that the bag 804 has been correctly positioned on the weighing device 803, whereafter the weighing operation takes place and the actual measured weight is displayed. The touch screen 802 then identifies the actual weight of the item of luggage, along with an indication of the extent to which the item of luggage is overweight. A further indication is provided as to how much would be charged were the item of luggage to be checked-in.

In an embodiment, a further output display is produced, by touch screen 802, asking if a re-weighing operation is to be performed, with a view to items of luggage being removed before the checking-in process is performed. If required, a ticket is printed with an alphanumeric code which is then manually entered upon return to the apparatus for the re-weighing process to be performed.

In an embodiment, if the apparatus identifies the weight as being under the passenger's allowance, an invitation message is issued via touch screen 802 inviting the passenger to proceed to check-in. It is also possible for a vending unit for foldaway luggage bags to be included in close proximity to the weighing apparatus. It is then possible for a passenger to purchase an additional luggage bag on the basis that a portion of the luggage could be transferred to hand luggage.

At step 1306 a session database is populated, such that the apparatus captures data as to where a passenger is going to, which airline they are going with and whether or not they are overweight. This data adds value to the airport and may be aggregated and presented as a monthly report.

As previously described, results are displayed at step 2307 and a question is asked at step 1308 as to whether a reweigh is required. When answered in the affirmative, the token is printed at step 1309, whereafter the session ends.

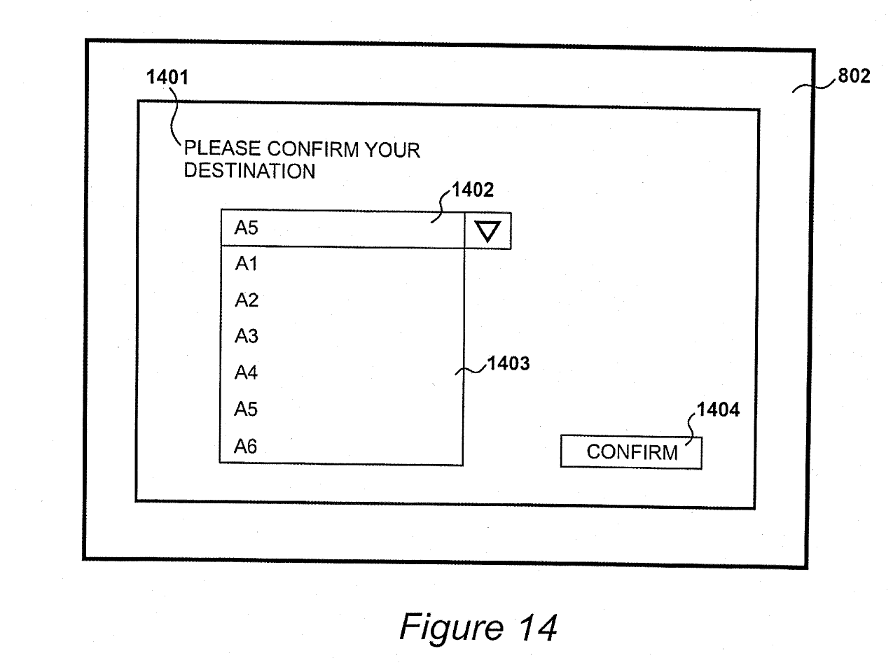

FIG. 14

As previously described, step 1302 receives a destination selection. In an embodiment, a graphical user interface is displayed on touch screen 802, as illustrated in FIG. 14. The interface requests a user to confirm their destination at region 1401. A text box 1402 appears, along with a pull down menu 1403 allowing a particular selection to be made. In this example, destination A6 has been selected and this is confirmed by the activation of confirm button 1404.

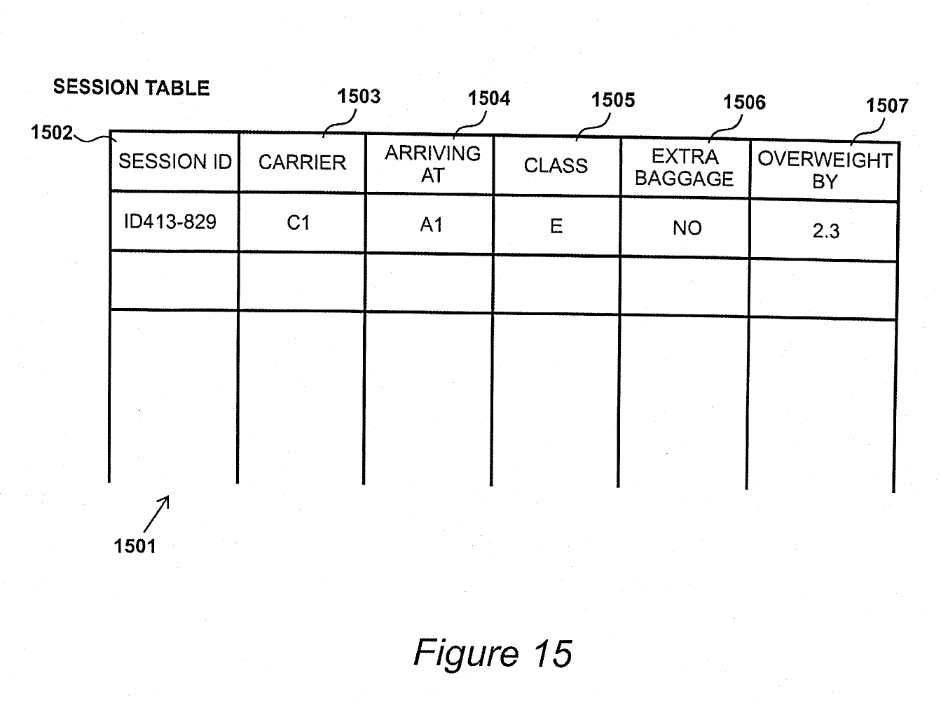

FIG. 15

At step 1306 a session database is populated. An example of a session table 1501, stored within a database on storage system 903, is illustrated in FIG. 15.

Each session is given a unique session identification number, recorded at column 1502. For each record, the carrier is recorded at column 1503 and a destination is recorded at column 1504. A class of ticket is recorded at column 1505 and an indication of additional weight is recorded at 1506. Finally, an indication of the extent to which the luggage was overweight is recorded at 1507.

In the example shown, a session has been given the unique identification 413-829. This represents ordinal session 829 occurring at apparatus 413. Carrier C1 is used for destination A1, using economy class, with no additional luggage payment and the measurement indicates that the luggage was overweight by 2.3 kilograms.

Periodically, session information is returned back to the control station 101, either in the form represented in the session table 1501 or in an aggregated form. Names and personal information are never received by the system and are not therefore recorded nor transmitted.

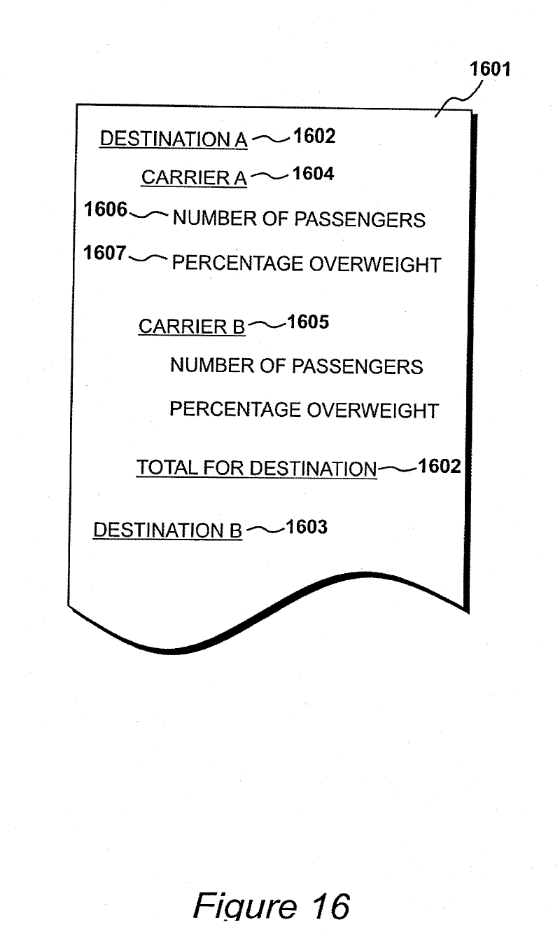

FIG. 16

As previously stated, an appreciation has been made to the effect that the information recorded in the session tables may be of particular interest to airport operators. Each session table relates to a specific apparatus and it is possible that several examples of the apparatus may be resident at each airport. For example, a large airport may have four terminals and three examples of the apparatus may be located within each terminal. Thus, a total of twelve examples of the apparatus are in use at a particular airport site.

At the control station 101, location table 205 identifies the location of each item of apparatus. Thus, as session tables are received, it is possible for control station 101 to identify the appropriate location for the data that has been received. Over time, this data may be processed and reports, such as report 1601 illustrated in FIG. 16, may be produced.

In the example shown in FIG. 16, a report has been produced for a particular airport. Thus, the information contained in this report has been derived from all of the apparatus located at the airport under consideration.

In this example, the information is broken down on a destination by destination basis such that the report starts with reference to destination A 1602 which is then followed by information concerning destination B 1603.

Within the information relating to each destination, the data is further sub-divided to identify each carrier taking passengers from the airport of interest to the destination of interest. Thus, carrier A is identified at 1604 and carrier B is identified at 1605.

For each carrier, the total number of passengers having luggage weighed is identified at 1606 and the percentage of these that are overweight is recorded at 1607.

Thus, an airport may make use of this information to identify patterns, such as particular carriers regularly having overweight luggage or particular destinations attracting overweight luggage.

1. A method of notifying a passenger as to whether an item of luggage is overweight, including the steps of:
receiving information relating to a journey for which a passenger has a ticket;
weighing said item of luggage to identify a weight for said item of luggage;
comparing said weight of said item of luggage with a maximum weight allowed value for a luggage item for said ticket; and
indicating the extent to which said item of luggage is overweight, wherein said step of receiving information relating to a journey includes:
receiving first data identifying a carrier for said journey; and
receiving second data identifying a destination; and
said maximum weight allowed value is read from a database with reference to said first data and said second data without requiring further details of the actual journey.

2. The method of claim 1, wherein said step of receiving information relating to a journey further includes receiving third data specifying a class of travel.

3. The method of claim 1, wherein said step of receiving information relating to a journey further includes receiving fourth data identifying the pre-purchase of an additional luggage allowance.

4. The method claim 2, wherein said step of receiving information relating to a journey further includes receiving fourth data identifying the pre-purchase of an additional luggage allowance.

5. The method of claim 1, wherein said step of indicating the extent to which the luggage is overweight includes identifying the actual weight of the luggage.

6. The method of claim 1, wherein said step of indicating the extent to which the luggage is overweight includes displaying how much additional charge would be incurred were the passenger to check-in the item of luggage.

7. The method of claim 1, wherein a token is dispensed to allow a re-weighing operation to be performed.

8. The method of claim 7, wherein said token takes the form of a printed code and said code is received as manually generated input data via a keypad to invoke a re-weighing operation.

9. The method of claim 1, further including the step of recording details of each session.

10. The method of claim 9, further including the step of producing aggregated output data from said recorded details of sessions.

11. The method of claim 10, further comprising the step of transmitting said aggregated output data to a control station.

12. Apparatus for notifying a passenger as to whether an item of luggage is overweight, including:
an input interface for receiving information relating to a journey for which a passenger has a ticket;
a weighing device for weighing said item of luggage;
a processing device for comparing the weight of said item of luggage with a maximum weight allowed value for an item of luggage with said ticket; and
a first output interface for indicating the extent to which the item of luggage is overweight, wherein said input interface receives information relating to a journey that includes:
first data identifying a carrier for said journey; and
second data identifying a destination; and
a database from which said maximum weight allowed value is read with reference to said first data and said second data without requiring further details of the actual journey.

13. The apparatus of claim 12, including an enclosure, wherein said database is retained locally within said enclosure.

14. The apparatus of claim 13, including a communication channel for receiving database updates.

15. The apparatus of claim 14, including a second output interface for supplying session data to a control station via said communication channel.

16. The apparatus of claim 13, wherein said communication channel is a radio telephony channel.

17. A database for use in a system for notifying a passenger as to whether an item of luggage is overweight, such that during a session a passenger identifies a journey and has an item of luggage weighed, including:
first data entries identifying carriers operational from the current location;
second data entries recording destinations for said identified carrier, such that:
a processor is configurable to indicate the extent to which an item of luggage is overweight by a query to said first data entries and a query to said second data entries, such that the extent to which the item of luggage is overweight is indicated without requiring further details of the actual journey.

18. The database of claim 17, wherein said first data entries are indexed, such that:
a query identifies one of said first data entries; and
a particular allowance for a luggage item is read from an identification of one of said second data entries.

19. The database of claim 16, further including third data entries specifying a class of travel.

20. The database of claim 16, further including fourth data entries detailing additional luggage allowances.

21. The database of claims 16, further including a data entry for the outcome of each session.
